(19) United States
(12) Patent Application Publication
(10) Pub. No.: US 2010/0230951 A1
(43) Pub. Date: Sep. 16, 2010

(54) SEAL FOR COUPLING DEVICE

(76) Inventor: Lee John Keeling, West Midlands (GB)

Correspondence Address: The Ollila Law Group LLC, 2569 Park Lane, SUITE 202, Lafayette, CO, 80026, US

(21) Appl. No.: 12/377,532

(22) PCT Filed: Sep. 5, 2007
(86) PCT No.: PCT/GB07/03356

§ 371 Date: Feb. 13, 2009

(30) Foreign Application Priority Data
Sep. 5, 2006 (GB) 0617516.0

(51) Int. Cl. F16L 21/035

(52) U.S. Cl. 285/93; 277/314

(57) ABSTRACT

A coupling device (1) including a first part (2) and a second part (3) is provided. The first and second parts are adapted to engage on another. The coupling device also includes an indicator seal (6) positioned on the first part. The indicator seal is visible when the coupling device is not fully engaged. Full engagement of the first and second part obscures the visibility of the indicator seal.

### TECHNICAL FIELD

This invention relates to a coupling device having a seal. In particular, it relates to a seal for sealing between a coupling device and an adapter. It is particularly applicable in a fluid pressure system such as a pneumatic system.

### BACKGROUND OF THE INVENTION

Coupling devices are used in pneumatic systems to connect the fluid flow port of an apparatus to a supply line. Typical industrial systems operate at up to 20 bar, and the supply lines are tubes with a diameter between 4 and 16 mm (OD), or equivalent imperial sizes. A coupling device usually comprises a housing with terminal portions. One or more terminal portions have tube coupling devices for a supply line, and another has an adapter sealingly retained on it, so that the fluid flow port can be connected to the adapter. The adapter may be for a swivel fitting, in which case it will need to rotate freely on the terminal portion, or a fixed fitting. The adapter may be connected to the coupling device by a clip. As the system has to cope with pressures up to or even beyond 60 bar, it is essential that the adapter is securely connected to the coupling device.

Such coupling devices are typically utilised in industrial applications and may be used in dusty or dirty environments. If dust or dirt enters the coupling, this may hinder the operation of the clip or other securing means, which is hazardous. Further, it is essential that during assembly, the adapter and the coupling device are securely connected together so that when the system is pressurised, the parts do not violently split apart, which may be dangerous.

### SUMMARY OF THE INVENTION

According to the present invention, we provide a coupling device comprising a first part and a second part adapted to be connected together by gripping means, a sealing means to seal between the first and second parts, and a further sealing means positioned such that it is visible to a user except when the gripping means has secured the first and second parts together and the sealing means has formed a reliable seal between the first and second parts.

This is advantageous as the further sealing means acts as an indicator for the user. The further sealing means is obscured when the first part and the second part are connected together reliably. The position of the further sealing means ensures that the user will push the first and second parts together sufficiently for the gripping means to engage fully and for the sealing means to form an effective seal. The sealing means preferably seals internal surfaces in the device. The further sealing means preferably seals external surfaces and so acts as an environmental seal to ensure that foreign bodies such as dust, dirt and moisture are prevented from entering the coupling device where they could interfere with the gripping means and sealing means.

The first part may be a housing of the coupling device and the second part may be an adapter for being received within the housing. Preferably the adapter is adapted to connect the tube coupling device to further apparatus.

The gripping means may comprise a clip. Preferably, the clip comprises an attachment portion to retain the clip on one of the first or second parts, and a plurality of resilient legs adapted to engage the other part. Preferably the clip is held in engagement with one of the first or second parts by a grip ring.

Preferably, the further sealing means is mounted on the first part and the second part includes a recess that receives the first part when the sealing and gripping means are fully engaged, and wherein the further sealing means is obscured from view within the recess.

Preferably the housing comprises a plurality of ports, at least one of which receives the adapter.

A coupling device is provided according to an embodiment of the invention. The coupling device comprises a first part and a second part adapted to engage on another. An indicator seal is positioned on the first part and visible when the coupling device is not fully engaged. Full engagement of the first part and the second part obscures the visibility of the indicator seal.

A method for forming a coupling device is provided according to an embodiment of the invention. The coupling device includes a first part and a second part adapted to engage one another. The method comprises the step of positioning an indicator seal on the first part such that the indicator seal is visible when the first part and the second part are not fully engaged and the indicator is obscured from view when the first part and the second part are fully engaged.

A method for determining full engagement of a coupling device is provided according to an embodiment of the invention. The coupling device includes a first part, a second part, and an indicator seal on the first part. The method for determining full engagement comprises the step of engaging the first part with the second part until the indicator seal is no longer visible, indicating full engagement of the coupling device.

### ASPECTS

According to one embodiment of the invention, the indicator seal forms a seal between the first part and the second part when fully engaged.

According to another embodiment of the invention, the indicator seal is positioned within a groove formed in a terminal portion of the first part.

According to yet another embodiment of the invention, the second part includes a recess adapted to receive the indicator seal when the first part and the second part are fully engaged.

According to yet another embodiment of the invention, the recess obscures the visibility of the indicator seal when the first part and the second part are fully engaged.

According to yet another embodiment of the invention, the indicator seal comprises a color different than the color of either the first part or the second part.

According to one method of the invention, the method further comprises the step of positioning the indicator seal such that it forms a seal between the first part and the second part when the coupling device is fully engaged.

According to another method of the invention, the method further comprises the step of forming a groove in a terminal portion of the first part and positioning the indicator seal within the groove.

According to yet another method of the invention, the method further comprises the step of forming a recess in the second part adapted to receive the indicator seal when the first part and the second part are fully engaged.

According to yet another method of the invention, the indicator seal comprises a color different than the color of either the first part or the second part.

### BRIEF DESCRIPTION OF THE DRAWINGS

FIG. 1 shows an embodiment of a coupling device of the invention prior to the gripping means and sealing means becoming fully engaged; and

FIG. 2 shows the embodiment of FIG. 1 in a fully engaged condition.

### DETAILED DESCRIPTION OF THE INVENTION

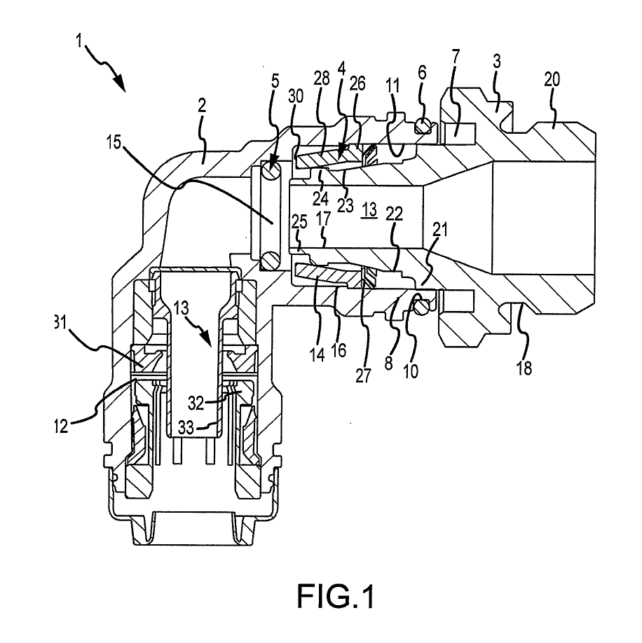

FIG. 1 shows a coupling device 1 comprising a housing 2, which forms a first part, and an adapter 3, which forms a second part. The housing 2 and adapter 3 are held together by a gripping means 4. A sealing means 5 is adapted to seal between internal surfaces of the two parts 2, 3. The housing 2 includes a further sealing means 6, referred to hereinafter as an “indicator seal”, and adapted to seal between external surfaces of the two parts 2, 3.

The housing 2 is L-shaped and comprises two ports 11, 12. The first port 11 is adapted to receive the adapter 3 and the second port 12 includes pipe coupling apparatus 13 to retain and seal against a pipe (not shown) that is pushed into port 12. The pipe coupling apparatus 13 comprises a lip seal 31 and a collet gripping means 32. The port 12 is adapted to receive a pipe (not shown), which is adapted to engage a tube support member 33, such that the member 33 is received within the tube. The sealing means 31 and the gripping means 32 engage with the external surface of the pipe.

The housing 2 is of a suitable engineering plastics material such as nylon. The port 11 has a stepped bore 13 to accommodate the adapter 3, which is of brass. The gripping means 4 comprises a clip 14, and the sealing means 4 comprises an O-ring 15. The clip 14 is located in the bore 13 at a shoulder 16 formed at a step in the bore 13.

The adapter 3 has an internal through-bore 17, and a stepped external surface 18. The adapter 3 includes a threaded connection 20 for connection to further apparatus, such as fluid flow apparatus. The adapter 3 shown is a swivel fitting, designed to rotate relative to the housing 2.

The inner end of the adapter 3 is received in the bore 11. Its external surface 18 has a first portion 21 that then steps down to a cylindrical portion 22 and then a tapered portion 23. A radially-outward extending flange 24 separates the tapered portion 23 from an end-portion 25.

The clip 14 is of plastics material, conveniently nylon, like the housing 2. The clip 14 has a solid attachment ring 26 by which it is attached to the housing 2, in this case by a metal grab ring 27. The clip 8 also has four legs 28 projecting from the ring 26, and angled radially inwardly. Each leg 22 gradually increases in thickness towards its free end, which provides an abutment 30 for the outer end of the flange 24, when the adapter 3 is fully inserted in bore 13.

The adapter 3 includes an annular recess 7, within which a terminal portion 8 of the housing 2 is adapted to be received. The indicator seal 6 is mounted within a groove 10 formed in the terminal portion 8. The indicator seal 6 is positioned such that it is received within the recess 7 only when the gripping means 4 has secured the housing 2 and the adapter 3 together and the sealing means 5 has formed a reliable seal between the two parts 2, 3. This is advantageous, as previously, the user would rely on “feeling” whether the parts are coupled together by the change in insertion force. This is unreliable as the insertion force changes several times as the adapter 3 begins to engage the gripping means 4 and then the sealing means 5. Therefore a user may incorrectly believe that the parts 2, 3 are fully engaged when the insertion force increases. The indicator seal 6 provides a clear visible indication of whether or not the parts 2, 3 are engaged due to whether or not it is visible.

The indicator seal 6 is coloured red to ensure it is clear and noticeable for a user. It will be appreciated that the indicator seal 6 does not have to be coloured red, but could be any colour. However, for ease of use it is preferable that the indicator seal has a colour that is in contrast to the first or second parts 2, 3.

FIG. 1 shows the coupling device 1 prior to the housing 2 and adapter 3 being fully engaged. Thus, the abutment 30 of the clip 14 is not in engagement with the flange 24 and the end-portion 25 has not formed a seal with O-ring 15. In the position shown in FIG. 1, the insertion force will begin to increase as the legs 28 of the clip 14 begin to ride radially outwardly over the flange 24. This increase in insertion force may cause the user to believe that the parts 2, 3 are engaged. However, indicator seal 6 is visible to the user, indicating that the parts 2, 3 are not fully engaged.

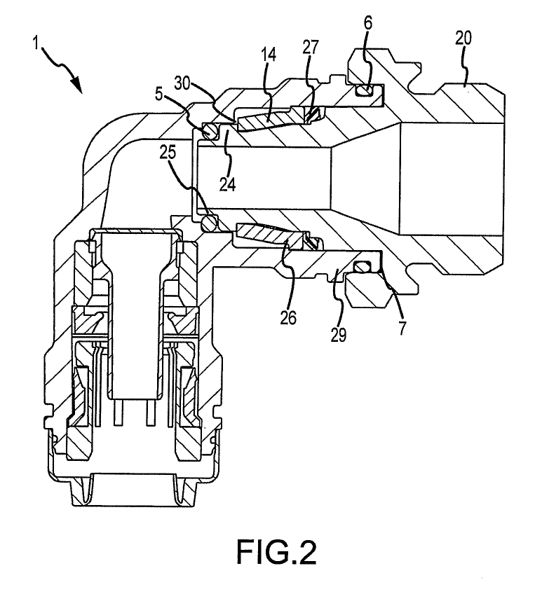

FIG. 2 shows the coupling device 1 when the housing 2 and adapter 3 are fully engaged. Thus, the legs 28 have resiled back to their original position such that the abutment 30 is securely engaged with flange 24. Also, end-portion 25 is in sealing engagement with the inside surface of O-ring 15. Accordingly, the indicator seal 6 is obscured from the view of the user as the terminal portion 8 of the housing 2 has been received within recess 7 of the adapter 3. This is therefore indicative of the fully engaged condition shown in FIG. 2. The adapter 3 also abuts an annular flange 29 on the external surface of the housing 2. Further, the indicator seal 6 acts to prevent dust, dirt and moisture entering the device 1, which may interfere with abutment 30 engaging securely with flange 24 or end-portion 25 forming a reliable seal with seal 15.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other coupling devices, and not just to the embodiments described above and shown in the accompanying figures. Accordingly, the scope of the invention should be determined from the following claims.

We claim:

1. A coupling device (1) comprising:
a first part (2) and a second part (3) adapted to engage one another; and
an indicator seal (6) positioned on the first part (2) and visible when the coupling device is not fully engaged;
wherein full engagement of the first part (2) and second part (3) obscures the visibility of the indicator seal (6).

2. The coupling device (1) of claim 1, wherein the indicator seal (6) forms a seal between the first part (2) and the second part (3) when fully engaged.

3. The coupling device (1) of claim 1, wherein the indicator seal (6) is positioned within a groove (10) formed in a terminal portion (8) of the first part (2).

4. The coupling device (1) of claim 1, wherein the second part (3) includes a recess (7) adapted to receive the indicator seal (6) when the first part (2) and the second part (3) are fully engaged.

5. The coupling device (1) of claim 4, wherein the recess (7) obscures the visibility of the indicator seal (6) when the first part (2) and the second part (3) are fully engaged.

6. The coupling device (1) of claim 1, wherein the indicator seal (6) comprises a color different than the color of either the first part (2) or the second part (3).

7. A method for forming a coupling device including a first part and a second part adapted to engage one another, comprising the step of:
positioning an indicator seal on the first part such that the indicator seal is visible when the first part and the second part are not fully engaged and the indicator seal is obscured from view when the first part and the second part are fully engaged.

8. The method of claim 7, further comprising the step of positioning the indicator seal such that it forms a seal between the first part and the second part when the coupling device is fully engaged.

9. The method of claim 7, further comprising the step of forming a groove in a terminal portion of the first part and positioning the indicator seal within said groove.

10. The method of claim 7, further comprising the step of forming a recess in the second part adapted to receive the indicator seal when the first part and the second part are fully engaged.

11. The method of claim 7, wherein the indicator seal comprises a color different than the color of either the first part or the second part.

12. A method for determining full engagement of a coupling device including a first part, a second part, and an indicator seal positioned on the first part, comprising the step of:
engaging the first part with the second part until the indicator seal is no longer visible, indicating full engagement of the coupling device.
